(19) United States
(12) Patent Application Publication
(10) Pub. No.: US 2012/0313586 A1
(43) Pub. Date: Dec. 13, 2012

(54) AUTOMOTIVE ELECTRIFIED DRIVE TRAIN SYSTEMS WITH HIGH TEMPERATURE RECHARGEABLE ENERGY STORAGE DEVICE

(75) Inventors: Riccardo Signorelli, Cambridge, MA (US); John Cooley, Cambridge, MA (US)

(73) Assignee: FastCAP Systems Corporation, Boston, MA (US)

(21) Appl. No.: 13/492,514

(22) Filed: Jun. 8, 2012

Related U.S. Application Data
(60) Provisional application No. 61/495,228, filed on Jun. 9, 2011.

(51) Int. Cl. H01G 9/00; H01R 43/00; H02J 7/00; B82Y 30/00

(52) U.S. Cl. 320/128; 361/502; 320/167; 29/825; 977/948

(57) ABSTRACT

A propulsion energy storage system for a hybrid vehicle includes ultracapacitor based energy storage to provide rechargeable energy storage. The rechargeable energy storage used performs well over a wide thermal range and thus permits vehicle designers and manufacturers to forego incorporation of temperature management systems. Further, as the rechargeable energy storage exhibit excellent thermal stability, the form factor of the cells of the rechargeable energy storage (e.g., ultracapacitors) may be adjusted to meet the desires of designers, manufacturers and users.

### CROSS REFERENCE TO RELATED APPLICATIONS

This application is filed under 35 U.S.C. §111(a), and claims priority under 35 U.S.C. §119(e) to U.S. Provisional Patent Application No. 61/495,228, filed Jun. 9, 2011, the entire disclosure of which is incorporated by reference herein in it's entirety.

### BACKGROUND OF THE INVENTION

1. Field of the Invention

The invention generally relates to hybrid vehicle propulsion, and more specifically to a hybrid vehicle power system that may include a high temperature rechargeable energy storage system.

2. Description of the Related Art

Many electrified drive train systems require rechargeable energy storage to operate properly. Exemplary vehicles with electrified drive train systems include micro hybrid electric vehicles (uHEV), mild hybrid electric vehicles (mHEV), full hybrid electric vehicles (HEV), plug-in hybrid electric vehicles (PHEV), range extended electric vehicles (REEV) and full electric vehicles (EV). uHEV's normally include systems enabling rapid ignition of an internal combustion engine (ICE). Those systems normally include an electrical motor or motor/generator and a rechargeable energy storage (RES). One useful application of the uHEV drivetrain allows the ICE to deactivate when the vehicle motion ceases and then to be rapidly reactivated when the user demands power from the ICE. The stop-start use may lead to fuel savings by allowing the ICE to completely shut off when power demand is low, such as when idling at a traffic light. A typical energy capacity and power handling capability of an RES in an uHEV varies in the range 0.1 to 100 Wh and 0.1 to 100 kW, respectively.

mHEV' s normally include systems enabling the capabilities found in uHEV' s and additionally include systems to provide a power assist from an electrical motor and electrical rechargeable energy storage as well as braking energy recovery. The power assist may complement the ICE during periods of high acceleration. The resulting decrease in high power loading of the ICE may lead to fuel savings beyond those yielded by an uHEV drivetrain. The recovery of braking energy to the energy storage may also yield a fuel savings. A typical energy capacity and power handling capability of an RES in a mHEV varies in the range of about 50 to 500 Wh and 10 to 500 kW, respectively.

HEV' s normally include systems enabling the capabilities found in mHEV' s and additionally include systems enabling temporary fully electrified drive. A typical energy capacity and power handling capability of an RES in an HEV varies in the range of about 100 to 1,000 Wh and 10 to 500 kW, respectively

PHEV' s normally include systems enabling the capabilities found in HEV' s and additional systems enabling on board rechargeable energy storage to be recharged from an off board supply of energy, for example a PHEV may be recharged by plugging in a cable to a wall outlet that is supplied with electricity from the utility. A typical energy capacity and power handling capability of an RES in a PHEV varies in the range 500 to 10,000 Wh and 50 to 400 kW, respectively.

REEV' s normally include systems enabling the capabilities found in PHEV's and additionally systems enabling full electric drive for longer durations, for example 40 miles. A typical energy capacity and power handling capability of an RES in a REEV varies in the range of about 500 to 20,000 Wh and 50 to 400 kW, respectively.

EV' s normally include systems enabling all of the above but do not have an ICE on-board for propulsion. A typical energy capacity and power handling capability of an RES in an EV varies in the range of about 10,000 to 200,000 Wh and 100 to 1,000 kW, respectively.

All of the exemplary and also other vehicles with electrified drive trains normally require rechargeable energy storage (RES) to operate properly. A requirement for RES on-board creates design constraints that may be limiting to the designer and ultimately the end-user. For example, an RES suitable for an HEV may exhibit a volume approximately equal to 0.5 m². In many cases, RES specifications require that the RES be placed in the passenger cabin of the automobile, for instance to comply with safe operating temperatures specified for the RES. An RES of approximately said volume placed inside the passenger cabin may occupy a significant space that may be otherwise advantageous for other uses.

Additionally, the power handling requirements for some electrified drive trains may be limiting to the designer and ultimately the end-user. For example, an RES suitable for an EV may need to exhibit a power handling capability of approximately 200 kW. Some RES technologies available today exhibit volumes of several meters cubed in order to achieve said power handling capability. Again, an RES of approximately said volume placed inside the passenger cabin or otherwise may occupy a significant space that may be otherwise advantageous for other uses. In the case of the EV, the problem is significantly exacerbated when compared to other electrified drive train types.

Thus, what are needed are rechargeable energy storage (RES) systems that provide designers, manufacturers and users of all sorts of hybrid vehicles with a stable power supply. Preferably, the RES is not constrained by environmental considerations, and can operate effectively in a high temperature environment.

### SUMMARY OF THE INVENTION

A propulsion energy storage system for a hybrid vehicle includes ultracapacitor based energy storage to provide rechargeable energy storage. The rechargeable energy storage used performs well over a wide thermal range and thus permits vehicle designers and manufacturers to forego incorporation of temperature management systems. Further, as the rechargeable energy storage exhibit excellent thermal stability, the form factor of the cells of the rechargeable energy storage (e.g., ultracapacitors) may be adjusted to meet the desires of designers, manufacturers and users.

### BRIEF DESCRIPTION OF THE DRAWINGS

The invention will be more fully understood by reference to the detailed description, in conjunction with the following figures, wherein:

FIG. 1 depicts aspects of an ultracapacitor, in this example, an electrochemical double-layer capacitor (EDLC);

FIG. 2 is a cutaway view of an exemplary rechargeable energy storage (RES);

FIG. 3 is an electrical diagram depicting an exemplary topology for load management using the rechargeable energy storage (RES);

FIG. 4 is a block diagram of aspects of a hybrid vehicle power system with under-hood placement of energy storage;

FIG. 5 depicts an exemplary vehicle including the rechargeable energy storage (RES);

and

FIG. 6 depicts an embodiment where the rechargeable energy storage (RES) is placed on an underside of the vehicle.

### DETAILED DESCRIPTION OF THE INVENTION

Disclosed herein are rechargeable energy storage devices suited for use in various types of vehicles. Among other things, the RES provide power adequate for moving the vehicle and/or driving components thereof. In exemplary embodiments, the rechargeable energy storage (RES) include ultracapacitors. Embodiments of ultracapacitors disclosed herein provide for superior operational stability over a wide range of temperatures, and therefore facilitate design and manufacture of the vehicles. Further, certain electrical characteristics exhibited by the ultracapacitors provide designers and manufacturers with flexibility. This flexibility leads to economic operation and maintenance of the vehicle.

Given the flexibility that is afforded to designers and manufacturers, the RES disclosed herein may be used in a variety of vehicle types. For example, the RES may be used in micro hybrid electric vehicles (uHEV), mild hybrid electric vehicles (mHEV), full hybrid electric vehicles (HEV), plug-in hybrid electric vehicles (PHEV), range extended electric vehicles (REEV) or full electric vehicles (EV), or any other kind of electrified vehicle.

Generally, the RES includes a high-temperature ultracapacitor (HTU). Ultracapacitors (also referred to as supercapacitors, electrical double-layer capacitors, or electrochemical capacitors, and by other similar terms), are energy storage devices that can have energy densities orders of magnitude greater than conventional capacitors and power densities orders of magnitude greater than conventional batteries. Some exemplary embodiments are provided.

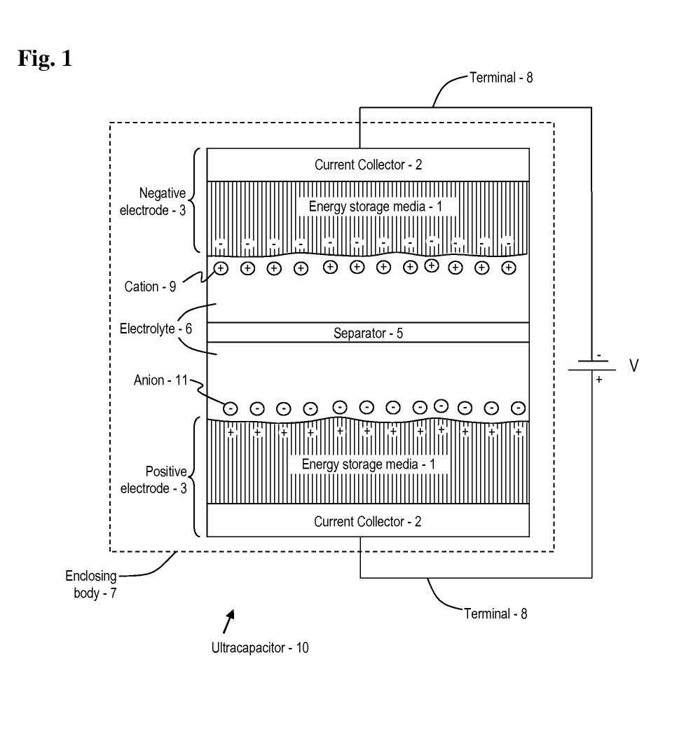

As shown in FIG. 1, an exemplary embodiment of an “ultracapacitor 10” is shown. In this case, the ultracapacitor 10 is an electric double-layer capacitor (EDLC). The EDLC includes at least one electrode 3 (in some cases, such as where there are two electrodes 3, the electrodes may be referred to as a negative electrode 3 and a positive electrode 3). When assembled into the ultracapacitor 10, each electrode 3 presents a double layer of charge at an electrolyte interface. In some embodiments, a plurality of electrodes 3 is included. However, for purposes of discussion, only two electrodes 3 are shown. As a matter of convention herein, at least one of the electrodes 3 uses a carbon-based energy storage media 1 (as discussed further herein) to provide energy storage.

Each of the electrodes 3 includes a respective current collector 2 (also referred to as a “charge collector”). The electrodes 3 are separated by a separator 5. In general, the separator 5 is a thin structural material (usually a sheet) used to separate the electrodes 3 into two or more compartments.

At least one form of electrolyte 6 is included, and fills void spaces in and between the electrodes 3 and the separator 5. In general, the electrolyte 6 is a substance that disassociates into electrically charged ions. A solvent that dissolves the substance may be included in some embodiments. A resulting electrolytic solution conducts electricity by ionic transport.

Generally, a combination of the electrode(s) 3 and the separator 5 are then formed into one of a wound form or prismatic form which is then packaged into a cylindrical or prismatic enclosing body 7. Once the electrolyte 6 has been included, the enclosing body 7 is hermetically sealed. In various examples, the package is hermetically sealed by techniques making use of laser, ultrasonic, and/or welding technologies. The enclosing body 7 (also referred to as a “enclosing body” or “case” or by other similar terms) includes at least one terminal 8. Each terminal 8 provides electrical access to energy stored in the energy storage media 1, generally through electrical leads (not shown) which are coupled to the energy storage media 1.

That is, in some embodiments, a plurality of leads (not shown) are electrically coupled to each of the current collectors 2. Each plurality (accordingly to a polarity of the ultracapacitor 10) are grouped and coupled to respective terminals 8 of the enclosing body 7.

In the exemplary EDLC, the energy storage media 1 is formed of carbon nanotubes. The energy storage media 1 may include other carbonaceous materials including, for example, activated carbon, carbon fibers, rayon, graphene, aerogel, carbon cloth, and a plurality of forms of carbon nanotubes. Activated carbon electrodes can be manufactured, for example, by producing a carbon base material by carrying out a first activation treatment to a carbon material obtained by carbonization of a carbon compound, producing a formed body by adding a binder to the carbon base material, carbonizing the formed body, and finally producing an active carbon electrode by carrying out a second activation treatment to the carbonized formed body. Carbon fiber electrodes can be produced, for example, by using paper or cloth pre-form with high surface area carbon fibers. The fabrication of carbon nanotubes and application of the nanotubes in the ultracapacitor 10 is discussed in detail further herein.

Accordingly, in some embodiments, material used to form the energy storage media 1 may include material other than pure carbon (and the various forms of carbon as may presently exist or be later devised). That is, various formulations of other materials may be included in the energy storage media 1. More specifically, and as a non-limiting example, at least one binder material may be used in the energy storage media 1, however, this is not to suggest or require addition of other materials (such as the binder material). In general, however, the energy storage media 1 is substantially formed of carbon, and may therefore referred to herein as a “carbonaceous material,” as a “carbonaceous layer” and by other similar terms. In short, although formed predominantly of carbon, the energy storage media 1 may include any form of carbon (as well as any additives or impurities as deemed appropriate or acceptable) to provide for desired functionality as energy storage media 1.

Some embodiments of various forms of carbonaceous material suited for use in energy storage media 1 are provided herein as examples. These embodiments, discussed below, provide robust energy storage and are well suited for use in the electrode 3. It should be noted that these examples are illustrative and are not limiting of embodiments of carbonaceous material suited for use in energy storage media 1.

The electrolyte 6 includes a pairing of cations 9 and anions 11 and may include a solvent. Various combinations of each may be used. In the exemplary EDLC, the cations 9 may include at least one of 1-(3-Cyanopropyl)-3-methylimidazolium, 1,2-Dimethyl-3-propylimidazolium, 1,3-Bis(3-cyanopropyl)imidazoliu, 1,3-Diethoxyimidazolium, 1-Butyl-1-methylpiperidinium, 1-Butyl-2,3-dimethylimidazolium, 1-Butyl-3-methylimidazolium, 1-Butyl-4-methylpyridinium, 1-Butylpyridinium, 1-Decyl-3-methylimidazolium, 1-Ethyl-3-methylimidazolium, 3-Methyl-1-propylpyridinium, and combinations thereof as well as other equivalents as deemed appropriate.

Additional exemplary cations 9 include imidazolium, pyrazinium, piperidinium, pyridinium, pyrimidinium, and pyrrolidinium. Generally, these cations 9 were selected as exhibiting high thermal stability, a low glass transition temperature (Tg), as well as high conductivity and exhibited good electric performance over a wide range of temperatures. Accordingly, other embodiments of cations 9 that exhibit desired properties may be used as well or in conjunction with any of the foregoing.

In the exemplary EDLC, the anions 11 may include at least one of bis(trifluoromethanesulfonate)imide, tris(trifluoromethanesulfonate)methide, dicyanamide, tetrafluoroborate, hexafluorophosphate, trifluoromethanesulfonate, bis(pentafluoroethanesulfonate)imide, thiocyanate, trifluoro(trifluoromethyl)borate, and combinations thereof as well as other equivalents as deemed appropriate.

The solvent may include acetonitrile, amides, benzonitrile, butyrolactone, cyclic ether, dibutyl carbonate, diethyl carbonate, diethylether, dimethoxyethane, dimethyl carbonate, dimethylformamide, dimethylsulfone, dioxane, dioxolane, ethyl formate, ethylene carbonate, ethylmethyl carbonate, lactone, linear ether, methyl formate, methyl propionate, methyltetrahydrofuran, nitrile, nitrobenzene, nitromethane, n-methylpyrrolidone, propylene carbonate, sulfolane, sulfone, tetrahydrofuran, tetramethylene sulfone, thiophene, ethylene glycol, diethylene glycol, triethylene glycol, polyethylene glycols, carbonic acid ester, y-butyrolactone, nitrile, tricyanohexane, any combination thereof or other material(s) that exhibit appropriate performance characteristics.

The separator 5 may be fabricated from non-woven glass. The separator 5 may also be fabricated from fiberglass, ceramics and fluoro-polymers, such as polytetrafluoroethylene (PTFE), commonly marketed as TEFLON™ by DuPont Chemicals of Wilmington, Del.. For example, using non-woven glass, the separator 5 can include main fibers and binder fibers each having a fiber diameter smaller than that of each of the main fibers and allowing the main fibers to be bonded together.

In general, the term “electrode” refers to an electrical conductor that is used to make contact to another material which is often non-metallic, in a device that may be incorporated into an electrical circuit. Exemplary second materials in an energy storage media may be of various forms including solid, liquid and gaseous. The materials of the energy storage media 1 may include conductive materials, semiconductors, electrolyte and the like. Generally, the term “electrode,” as used herein, is with reference to the energy storage media 1 and the additional components as may accompany the energy storage media 1 to provide for desired functionality (for example, the current collector 2 which is mated to the energy storage media 1).

Once the EDLC is fabricated, it may be used in high temperature applications with little or no leakage current, little increase in resistance and little decrease in capacitance. The EDLC described herein can operate efficiently at temperatures from about 20 degrees Celsius to about 210 degrees Celsius with leakage currents normalized over the volume of the device less than 1 amp per liter (A/L) of volume of the device within the entire operating voltage and temperature range. Embodiments, of the EDLC described herein exhibit capacitance decreases of less than 50 per cent over 2,500 cycles while operating at its maximum voltage in its operating temperature range and whose resistance increases less than 100% over the same 2,500 cycles.

One key to this performance is the assembly process itself, which produces a finished EDLC having a moisture concentration in the electrolyte of less than 500 parts per million (ppm) over the weight and volume of the electrolyte and an amount of impurities less than 1000 ppm.

More specifically, in various embodiments, the activated carbon, carbon fibers, rayon, carbon cloth, and/or nanotubes making up the energy storage media 1 for the two electrodes 3 are dried at elevated temperature in a vacuum environment. The separator 5 is also dried at elevated temperature in a vacuum environment. The electrolyte 6 is dried at elevated temperature in a vacuum environment. Once the electrodes 3 the separator 5, and electrolyte 6 are dried under vacuum, they are packaged in the enclosing body 7 without a final seal or cap in an atmosphere with less than 50 parts per million (ppm) of water. The uncapped EDLC is dried under vacuum over a temperature range of 100 degrees Celsius to about 200 degrees Celsius. Once this final drying is complete, the enclosing body 7 is sealed in an atmosphere with less than 50 ppm of moisture.

In addition, impurities in the electrolyte 6 are kept to a minimum. For example, in some embodiments, a total concentration of halide ions (chloride, bromide, fluoride, iodide), is kept to below 1,000 ppm. A total concentration of metallic species (e.g., Br, Cd, Co, Cr, Cu, Fe, K, Li, Mo, Na, Ni, Pb, Zn, including an at least one of an alloy and an oxide thereof), is kept to below 1,000 ppm. Further, impurities from solvents and precursors used in the synthesis process are kept below 1,000 ppm and can include, for example, bromoethane, chloroethane, 1-bromobutane, 1-chlorobutane, 1-methylimidazole, ethyl acetate, methylene chloride and so forth.

One example of a technique for purifying electrolyte is provided in a reference entitled “The oxidation of alcohols in substituted imidazolium ionic liquids using ruthenium catalysts,” Farmer and Welton, The Royal Society of Chemistry, 2002, 4, 97-102.

Impurities can be measured using a variety of techniques, such as, for example, Atomic Absorption Spectometry (AAS), Inductively Coupled Plasma-Mass Spectometry (ICPMS), or simplified solubilizing and electrochemical electrochemical sensing trace heavy metal oxide particulates based on a task specific ionic liquid.

AAS is a spectro-analytical procedure for the qualitative and quantitative determination of chemical elements employing the absorption of optical radiation (light) by free atoms in the gaseous state. The technique is used for determining the concentration of a particular element (the analyte) in a sample to be analyzed. AAS can be used to determine over 70 different elements in solution or directly in solid samples.

ICPMS is a type of mass spectrometry that is highly sensitive and capable of the determination of a range of metals and several non-metals at concentrations below one part in 1012 (part per trillion). It is based on coupling together an inductively coupled plasma as a method of producing ions (ionization) with a mass spectrometer as a method of separating and detecting the ions. ICP-MS is also capable of monitoring isotopic speciation for the ions of choice.

By reducing the moisture content in the EDLC to less than 500 part per million (ppm) over the weight and volume of the electrolyte and the impurities to less than 1,000 ppm, the EDLC can efficiently operate over a wide temperature range suited for use with the teachings herein, with a leakage current (I/L) that is less than 1,000 mAmp per Liter within that temperature and voltage range.

In one embodiment, leakage current (I/L) at a specific temperature is measured by holding the voltage of the EDLC constant at the rated voltage (i.e., the maximum rated operating voltage) for seventy five (75) hours. During this period, the temperature remains constant at the specified temperature. At the end of the measurement interval, the leakage current of the EDLC is measured.

In some embodiments, a maximum voltage rating of the EDLC is 4 V at room temperature. An approach to ensure performance of the EDLC at elevated temperatures (for example, over 210 degrees Celsius), is to derate (i.e., to reduce) the voltage rating of the EDLC. For example, the voltage rating may be adjusted down to about 0.5 V, such that extended durations of operation at higher temperature is achievable.

The RES may be embodied in several different form factors (i.e., exhibit a certain appearance). Examples of potentially useful form factors include, a cylindrical cell, an annular or ring-shaped cell, a flat prismatic cell or a stack of flat prismatic cells comprising a box-like cell, and a flat prismatic cell that is shaped to accommodate a particular geometry such as a curved space. A cylindrical form factor may be most useful in conjunction with a cylindrical tool or a tool mounted in a cylindrical form factor. An annular or ring-shaped form factor may be most useful in conjunction with a tool that is ring-shaped or mounted in a ring-shaped form factor. A flat prismatic cell shaped to accommodate a particular geometry may be useful in conjunction with cylindrical, ring-shaped or other tools or tools mounted in those form factors.

By reducing the moisture content in the EDLC to less than 500 part per million (ppm) over the weight and volume of the electrolyte and the impurities to less than 1,000 ppm, the EDLC can efficiently operate over a temperature range of about minus 20 degrees Celsius to about 150 degrees Celsius with a leakage current less than 1 Amp per Liter within the temperature and voltage range. In addition, embodiments of the EDLC described herein exhibit capacitance decreases of less than 50% over 2,500 cycles while operating at its maximum voltage in its operating temperature range, and whose resistance increases less than 100% over the same 2,500 cycles.

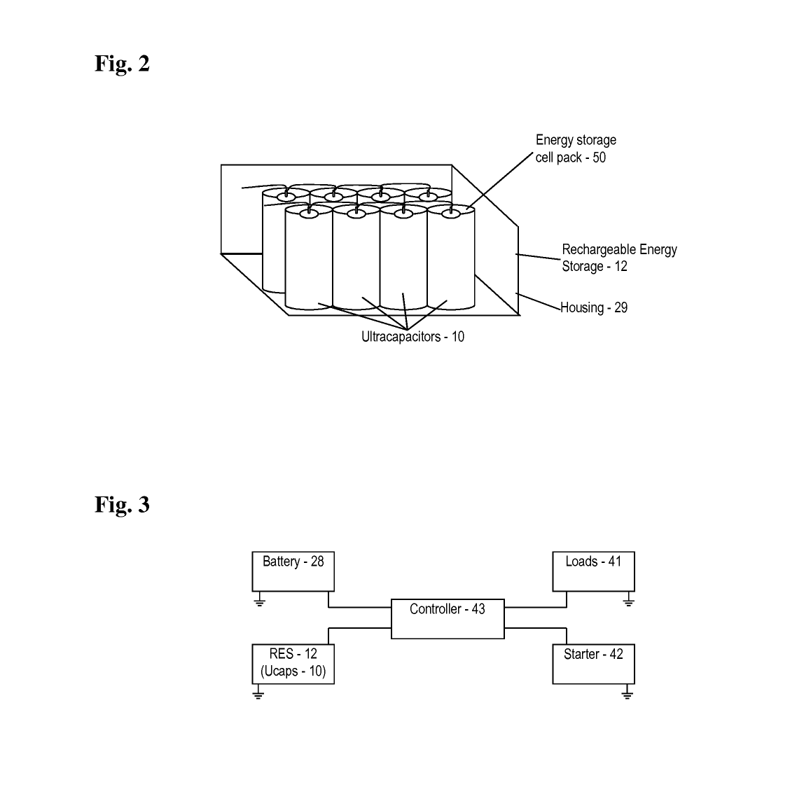

Referring now to FIG. 2, there is shown an exemplary rechargeable energy storage (RES) 12. In this embodiment, the RES 12 makes use of a plurality of the ultracapacitors 10. The ultracapacitors 10 may be assembled into an energy storage cell pack 50 which includes a protective housing 29. In this example, the ultracapacitors 10 are rated for operation in temperatures ranging from about minus 30 degrees Celsius to about 150 degrees Celsius while exhibiting safe and useful operation. As a corollary to the high power capability of the ultracapacitors 10, they exhibit low internal dissipation. Combining this low internal dissipation with the sufficiently high maximum cell temperature of 150 degrees Celsius, there is little to no need for active cooling or modification of the cell pack 50 specifically to improve heat dissipation. In addition, having a useful operating temperature range extending downward to minus 30 degrees Celsius, there is generally no need to actively heat the energy storage system.

In some embodiments, the RES 12 is rated for operation within smaller temperature ranges. For example, the RES 12 may be rated for operation between about minus 3 degrees Celsius to about 90 degrees Celsius.

Thus, a hybrid vehicle energy power system making use of the RES 12 generally does not rely on thermal management technologies for component cooling. That is, using appropriate ultracapacitors 10 in place of traditional batteries permits designers and manufacturers to forego incorporation of traditional vehicle thermal management systems. While thermal management systems are capable of balancing the needs of multiple vehicle systems that may require heat for operation, require cooling to reject heat, or require operation within specified temperature ranges, such systems consume space and energy in a vehicle, and are costly to manufacture. Aspects of a control system are depicted in FIG. 3.

Refer to FIG. 3 where aspects of an exemplary controller 43 for an electrified drive train are depicted. A first energy storage (the battery 28), the rechargeable energy storage (RES 12), a starter motor 42 and various other electrical loads 41 (such as might be included in a conventional vehicle e.g. sound system, lights, and so on) are in electrical communication in an electrical circuit. A controller 43 may include a variety of components deemed useful for controlling the various components in the electrical circuit. For example, the controller 43 may include a processor, memory, storage, sensors, switches, gates, at least one interface, machine readable instructions stored on machine readable media (i.e., software) and the like. As the controller 43 senses demand, the controller 43 will draw upon at least one of the battery 28 and the RES 12 to supply power. In some embodiments, a power supply (not shown) may be included. For example, in systems making use of regenerative braking, the power supply may provide power, which is directed by the controller 43. The controller 43 may control charging of at least one of the battery 28 and the RES 12 to a desired level.

Further exemplary aspects of operation of the controller 43 are now introduced with two exemplary embodiments.

In a first embodiment, the vehicle is a micro hybrid electric vehicle (uHEV). In this example, the battery 28 may be coupled to the electrical load(s) 41 without interruption while the starter and the RES 12 are only coupled to the battery 28 at certain times. The battery 28 may supply a recharge current to the RES 12 by coupling to the RES 12 via switching by the controller 43 when the RES 12 has been discharged sufficiently. The starter 42 may then be coupled only to the RES 12 (and not to the battery 28 or the loads 41) when re-start of the engine 20 is required. In this embodiment, exemplary advantages include the benefit that the battery 28 does not directly supply high pulses of current demanded by the starter 42. As a consequence, design criteria for the battery 28 may be significantly relaxed leading to a smaller, lighter battery 28 that may last significantly longer. This embodiment is advantageous in uHEV as well as various other electrified drive trains.

In another example, the RES 12 is coupled to the loads 41 without interruption. The battery 28 may be coupled to the RES 12 and the loads 41 when the starter 42 is not demanding power for ignition of the engine 20. When the engine 20 requires rapid ignition, the battery 28 may be coupled to the starter 42, while the battery 28 and starter 42 are both decoupled from the RES 12 and the loads 41. During this time, the RES 12 remains coupled to the loads 41. In this embodiment, referred to as “voltage stabilization,” the RES 12 is responsible for stabilizing the voltage bus for the loads 41, while the battery 28 is responsible for providing pulses of power to the starter 42. This embodiment may be advantageous when the battery technology design constraints are not substantially limited by the need to supply power to the starter 42. In this case, a smaller RES 12 may be useful as compared to other fashions of use. This may be beneficial when the RES 12 technology design constraints are limited by volume, weight or otherwise.

Switching among sources and loads can be implemented any number of ways. One example employs active devices (for instance, at least one MOSFET) in a current path for the various energy sources to be selected by the controller. For ground-referenced logic-level input MOSFETs, at least one of the controller and a digital supervisor may provide logic level control signals between the gates and sources of the MOSFETs to activate them. For instance, to activate one source and deactivate another, the MOSFET for the first source can be activated making a closed circuit connection between a first source and a load and the MOSFET for a second source deactivated breaking a closed circuit connection between a first source and a load. If ground-referenced MOSFETs are not considered suitable, MOSFETs may be similarly placed in a high potential current path. In this case, the gate to source voltage of the MOSFET may require a level shift circuit to confine the gate to source voltage presented at the MOSFET terminals to a safe range. In any case, the designer should consider the direction of inherent body diodes in active devices in order to effectively block current when a circuit is intended to be broken. Relays, analog switches, fuses, resettable fuses, transistors, isolated gate drives or isolated active devices, and any number of devices may all be useful in implementing switching among sources and loads. Switching among sources and loads may also be implemented in a more linear fashion. For instance, the amount of power drawn from one source may be controlled over a continuum for instance, by controlling a resistance placed in the current path of that source. This may also be implemented with transistors. The control signal in this case should resemble an analog rather than a digital or binary signal.

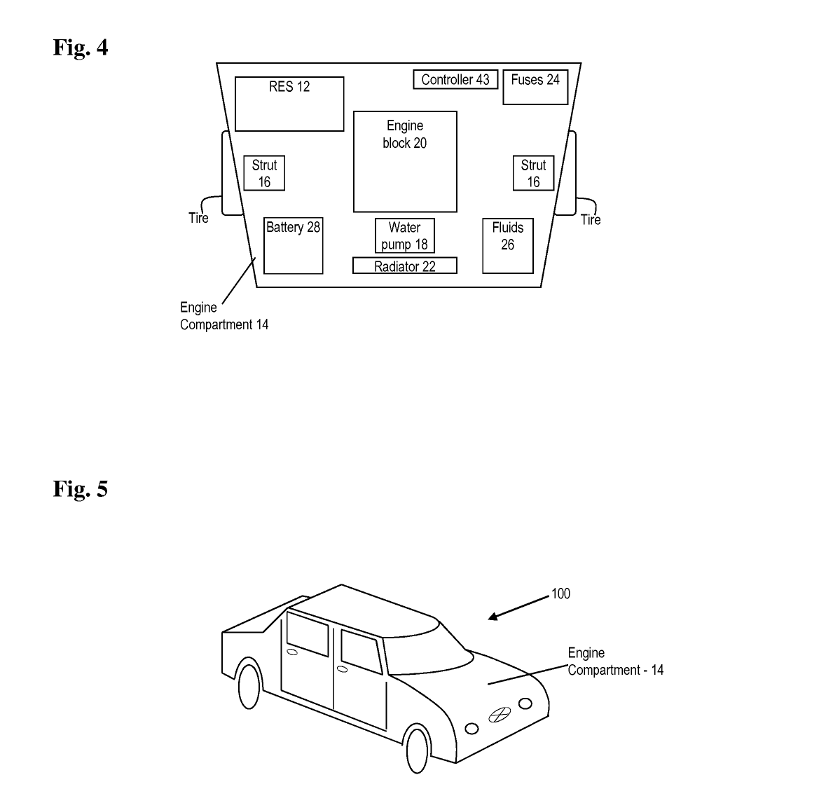

In order to provide some additional context, aspects of an exemplary vehicle are shown in FIG. 4. In this embodiment, the vehicle includes an embodiment of the rechargeable energy storage (RES 12) that is suited for high-temperature operations (a high temperature rechargeable energy storage, HTRES). The RES 12 is placed in an engine compartment 14 of the vehicle. Also within the engine compartment 14 is a pair of struts 16, a water pump 18, an engine 20 (such as an internal combustion engine, ICE), a radiator 22, a fuse box 24, the controller 43, fluids 26 and battery 28, as well as other equipment generally found in a vehicle.

In some embodiments, ambient temperatures to which the rechargeable energy storage (RES) 12 may be exposed may fall within a range about minus 30 degrees Celsius to about plus 105 degrees Celsius.

To fit within typical allotted space under a hood of the vehicle (underhood), the RES 12 generally has a volume that is less than about 0.5 m³, while providing at least 10 kW of power at 90% efficiency with a storage capacity of at least 100 Wh of energy.

A variety of operational and physical configurations may be realized with the components shown herein, as well as with other components as may be included in a conventional vehicle.

Referring now to FIG. 5, there is shown an exemplary vehicle 100 that makes use of the teachings herein. The vehicle 100 shown is a personal use vehicle, however, any type of vehicle requiring a rechargeable energy storage (RES) may make use of the teachings herein. Among other vehicles 100, included are light, medium, heavy and industrial duty vehicles. For example, vehicles which make use of the rechargeable energy storage (RES) to drive other implements as well, including, for example, hydraulic systems, connections to external loads, and other such systems. However, for purposes of simplicity, the teachings herein are directed to a personal use vehicle as the exemplary hybrid vehicle 100.

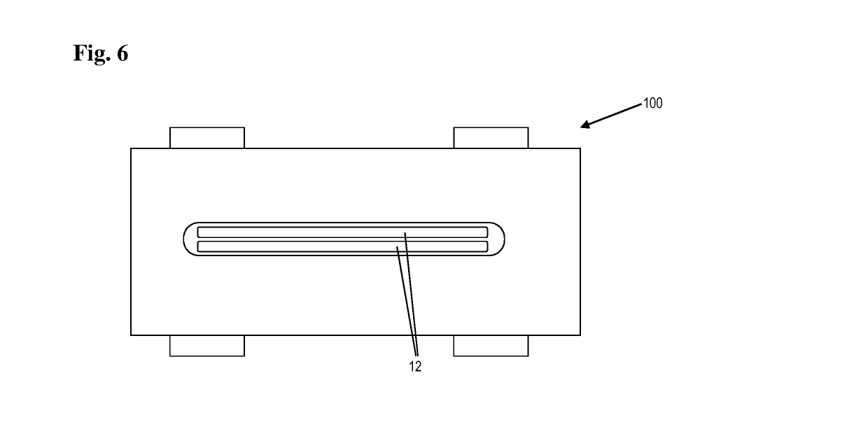

A high temperature RES 12 (HTRES) is particularly useful for alleviating design constraints in electrified drive train applications. Specifically, the HTRES may exhibit a safe operating temperature range extending to sufficiently high temperatures such that the HTRES may be placed on-board the vehicle 100, but not necessarily in the passenger cabin, for instance, under the hood in the engine compartment (underhood) or under the chassis of the vehicle (under chassis). Embodiments of the RES 12 may assume a variety of form factors, which can greatly assist designers with planning economic use of space within the vehicle. Consider the example depicted in FIG. 6.

Referring now to FIG. 6, there is shown an example where a form factor (i.e., shape, size, physical appearance and the like) has been adjusted. In this example, the RES 12 includes a plurality of oblong elements mounted on the underside of the chassis for the vehicle 1, such as along a drift shaft (not shown) from the engine 20. In other embodiments, the ultracapacitors 10 that form the RES 12 are distributed throughout the vehicle 100, essentially taking advantage of conventional “dead space” where ever it may be on board. In further examples, the RES 12 replaces at least a portion of other equipment, such as sound insulating material (for example, along the firewall, or under the hood, mounted thereon).

Further aspects of the teachings herein are now presented.

As a matter of convention, and for purposes of the teachings herein, as discussed herein, the term “ultracapacitor” refers to an energy storage device that, among other things, will operate in environments where a conventional energy storage device generally will fail. Exemplary and non-limiting aspects are provided herein. That is, in general, it should be considered that the ultracapacitors of the teachings herein, and others of equivalent form, will outperform the conventional energy storage device when placed in an equivalent environment and provide at least some degree of utility as a function of increasing temperature. Among other things, the ultracapacitors disclosed herein rely on carbon based energy storage media 1.

As discussed herein, the term “hybrid” generally refers to use of at least two forms of energy to drive a propulsion system. Generally, this refers to use of electric power to drive at least one electric motor, as well as another form (such as incorporation of an internal combustion engine to power a mechanical drive train). Given that the rechargeable energy storage disclosed herein may provide power under a variety of conditions, the rechargeable energy storage may be useful in a variety of systems that at least partially use electrical power. One example of another type of drive includes a diesel-electric drive (such is used in a conventional locomotive). Accordingly, the term “hybrid” is not limiting of the teachings herein.

In short, the RES disclosed herein, and the various other components as may be used with or in support of the RES may be used in any embodiment where stored electrical power is used in combination other sources of energy to provide a motive force.

The ultracapacitors disclosed herein reduce the complexity and cost of hybrid electric vehicles by providing higher power and energy density in a variety of environmental conditions (such as in a high temperature, environment). In some embodiments, this provides for seventy percent lower cost, leading to at least forty percent lower pack and hybridization costs.

The ultracapacitor 10 disclosed herein eliminates or substantially reduces the need for active thermal management systems by offering performance at high temperature combined with lower internal power dissipation (higher efficiency). This leads to cost savings and complexity reduction, among other advantages. Further, with the availability of space previously taken by thermal management systems, designers may incorporate additional energy storage, which can result in further efficiencies in operation.

In short, the rechargeable energy storage (RES) may generally be deployed in a electrified drive train. When the RES is a HTRES, further benefits may also be realized, (e.g. underhood or underchassis placement). When the HTRES exhibits sufficiently high power handling capability, the benefits therein described above regarding the elimination of any need for active thermal management may be exploited as well.

The deployment of a high temperature RES in electrified drive trains yields significant benefits. For example, designers may include only minimal active thermal management systems, or may be reliant on passive thermal management for protection of the rechargeable energy storage (RES). Given the improved performance characteristics of the HTRES, safe operating conditions for the HTRES may be realized even when the HTRES is placed outside of the passenger cabin. This represents a significant benefit because the mass and volume added by active thermal management systems is typically significant when compared to the mass and volume of the energy storage itself. This benefit is better exploited if the HTRES is a high power capability energy storage technology such as may be provided in embodiments of the high-temperature ultracapacitor (HTU). High power capability of an energy storage technology is coincident with low internal heat dissipation in the energy storage. Low internal heat dissipation leads directly to a reduced need to remove heat from the HTRES. Thus, in some embodiments, only passive rather than active thermal management may be sufficient for many designs that make use of the HTRES.

Having disclosed aspects of embodiments of the hybrid vehicle power system without active thermal management, it should be recognized that a variety of embodiments may be realized. Further a variety of techniques of fabrication may be had.

As a matter of convention, it should be considered that the term “may” as used herein is to be construed as optional; “includes” is to be construed as not excluding other options (i.e., steps, materials, components, compositions, etc, . . . ); “should” does not imply a requirement, rather merely an occasional or situational preference. Other similar terminology is likewise used in a generally conventional manner.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A rechargeable energy storage (RES) for a vehicle, the RES comprising:
at least one ultracapacitor adapted for operating at an ambient temperature up to about ninety degrees Celsius, wherein the RES comprises a form factor for making economic use of space within the vehicle.

2. The RES of claim 1, wherein the ultracapacitor comprises a carbonaceous material as an energy storage media.

3. The RES of claim 2, wherein the carbonaceous material comprises vertically aligned carbon nanotubes.

4. The RES of claim 1, wherein the ultracapacitor exhibits a capacitance decrease of less than about fifty percent over 2,500 cycles, while operating a maximum voltage.

5. The RES of claim 1, wherein the form factor is adapted for replacing insulation of the vehicle with the RES.

6. The RES of claim 1, comprising a volume of less than about 0.5 cubic meters, while providing at least 10 kW of power at about ninety percent efficiency with a storage capacity of at least 100 Wh of energy.

7. A method of fabricating a rechargeable energy storage (RES) for a vehicle, the method comprising:
selecting a plurality of ultracapacitors adapted for operating at an ambient temperature up to about ninety degrees Celsius;
electrically coupling the ultracapacitors together; and
disposing the coupled ultracapacitors into a housing.

8. The method of claim 7, wherein the coupling is at least one of a series coupling and a parallel coupling.

9. The method of claim 7, further comprising electrically coupling the RES to a controller for controlling at least one of charging and discharging of the ultracapacitors.

10. An energy power system for a hybrid vehicle, the system comprising:
a rechargeable energy storage (RES) comprising at least one ultracapacitor adapted for operating at an ambient temperature up to about ninety degrees Celsius as a first energy storage;
a second energy storage comprising a battery; and
a controller for controlling at least one of charging and discharging of the first and the second energy storage.

11. The system of claim 10, wherein the controller comprises at least one of a processor, a memory, a data storage, a sensor, a switch, a gate, an interface and machine readable instructions stored on machine readable media for the controlling.

12. The system of claim 11, wherein the controller is configured to draw upon at least one of the first energy storage and the second energy storage according to demand of a load.

13. The system of claim 11, wherein the controller is configured to charge at least one of the first energy storage and the second energy storage according to a state of charge and a rate of charge.

14. The system of claim 11, wherein the first energy storage is stored in dead space of the vehicle.

15. The system of claim 11, wherein at least the first energy storage is configured for operation without a thermal management system.

16. A method for providing power in a hybrid vehicle, the method comprising:
sensing a load demand for a high pulse of power;
decoupling a battery from the electrical bus; and
serving the demand by drawing power from a rechargeable energy storage (RES) comprising at least one ultracapacitor adapted for operating at an ambient temperature up to about ninety degrees Celsius; and
providing the power to the load.

17. The method of claim 16, wherein the load comprises one of a component of the vehicle and an external load coupled to the electrical bus.

18. A method for equipping a hybrid vehicle with an energy power system, the method comprising:
selecting a rechargeable energy storage (RES) comprising at least one ultracapacitor adapted for operating at an ambient temperature up to about ninety degrees Celsius as a first energy storage;
selecting a controller for controlling at least one of charging and discharging of the first energy storage and a battery of the vehicle;
incorporating the RES and the controller into the vehicle; and
coupling the RES and the controller to an electrical system of the vehicle.

19. The method of claim 18, further comprising coupling the controller to a battery of the vehicle.

20. The method of claim 18, wherein incorporating the RES comprises placing the at least one ultracapacitor into a dead space of the vehicle.

21. The method of claim 18, wherein selecting the RES comprises selecting an RES with an operational rating for servicing pulse power requirements of the vehicle.

22. The method of claim 18, wherein incorporating the RES comprises placing the at least one ultracapacitor into a harsh environment on-board the vehicle.
